(19) United States
(12) Patent Application Publication
(10) Pub. No.: US 2021/0062962 A1
(43) Pub. Date: Mar. 4, 2021

(54) Tablet Holder

(71) Applicant: Shun Chang, Newark, CA (US)

(72) Inventor: Shun Chang, Newark, CA (US)

(21) Appl. No.: 16/558,183

(22) Filed: Sep. 2, 2019

(51) Int. Cl. F16M 11/14; F16M 11/04

(52) U.S. Cl. CPC F16M 11/14; F16M 11/041; G06F 1/1626; F16M 2200/065; F16M 11/043

(57) ABSTRACT

Systems and methods are disclosed herein for completely automated assembly for tablet holder which is a high-quality Aluminium solid and well-designed smart devices holder, able to provide 360 degree viewing angles with inbuilt hinges to provide freedom from manually tightening screws, device risk of falling down and flawed or jerky movement. The device holder comprising magnet for mounting and dismounting the assembly and provides the charging capability within the structure as well.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

Embodiments relate to a tablet holder and adjustable systems and methods. More particularly, embodiments relate to a tablet personal computer or other electronic reading device holder remaining in a safe position, user-friendly storage, travel (Travel, transport, carrying) and viewing.

### Description of the Related Art

In recent years, most electronic devices (e.g. mobile phones, tablet computers, e-readers (eReaders), etc.) have been made in various sizes and shapes for the consumer public. In particular, these devices on the market under various trade transactions, e.g. Ipad® plate, Nook®, Kindle®, and various other known types of eReaders®. Because of these electronic devices has become public, it is readily available, so these devices are secured within the secure housing to use them for viewing, reading and for their safe placement, demand has become increasingly important.

Unlike with keys block by block, and the screen is articulated, the tablet consists of one single piece with integrated flat screen, the screen on the plane through the keyboard or automatically by means of invisible electronic input pen for input. As increasing pace of life and requirement of these smart devices are increasing day by day, the requirement for them placing at a proper position is also very much required. Whether user is reading the book at home, or required to read while travelling in car, or at hotel room, or in any institution requirement for holders in important.

There are multiple solutions that have been presented in prior art. For instance, means for mounting tablet bearing Canadian patent 1,028,69542B is issued to Chinese inventor. The patent relates to a tablet, particularly for a vehicle seat mounted in a vehicle such as a seat member (1) of the backrest (1a), a headrest (1b) or the headrest holding means (1c, 1c′, 1c″) means on the rear side, comprising: a fixation device (2a, 3a, 3b, 3c), said means for mounting on the vehicle seat member (1a, 1b, 1c, 1c′, 1c″); and support element (4, 40) fixed equipment (2a, 3a, 3b, 3c) movably connected to the holder (5,50) accommodating the tablet (6) of the support element is movably connected, wherein the holder (5,50) is movable between a first position of use and a second use state, wherein in the first state using the tablet (6) of the screen (6a) facing away from the vehicle toward the seat part (1a, 1b, 1c, side 1c′, 1c″) and oriented substantially perpendicular to, in a second usage state in the tablet (6) of the screen (6a) substantially horizontally and upwardly relative to the user, or obliquely oriented.

Another patent disclosing a Magnetic stand for tablet device bearing US patent 2,0160,174363A1 is issued to Apple Inc. The patent discloses a magnetic stand for a tablet device is disclosed. The magnetic stand is configured to rigidly hold a portion of the tablet device in place and to shield the magnetic field from adversely affecting nearby devices susceptible to strong magnetic fields. The shielding portion of the magnetic stand allows for significant increases in magnetic field strength when compared to similarly configured, unshielded products.

Another patent on tablets and monitor support systems bearing Canadian patent 1,039,88143B is issued to Chinese holder. The support system and related methods support for tablets and monitors. Comprising a bracket configured to support the monitor and monitor support portion configured to support the tablet, the tablet support portion.

Another Holder for tablet personal computer bearing U.S. Pat. No. 8,424,830B2 is issued to Chi Mei Communication Systems Inc. The patent discloses a holder for holding a portable electronic device can be changed between a folded position and an unfolded position. The holder holds the portable electronic device in the folded position. In the unfolded position, the holder has its supporting board, front holding board, rear holding board, side holding boards, bottom holding boards substantially planar with each other. In the folded position, the supporting board supports the side holding boards to vertically stand, the rear holding board is secured above the supporting board at an obtuse angle, and the front holding board is maintained parallel with the rear holding board.

Another Tablet stand bearing US patent is issued to U.S. Pat. No. 5,607,135A to Hiroshi Yamada. The patent discloses a foldable one-piece tablet stand comprising a base section, a back rest section which can be raised and lowered into the base section, a pair of protrusions which can be raised and lowered into the base and disposed at a front part of the base section so that when both the back rest section and protrusions are in the raised conditions, a tablet will be held by the back rest section with a bottom of the tablet held by the base section and secured by the pair of protrusions, and a holder section which is foldable into the base section and hinged on the back of the back rest section and held on parts of the base section so that the back rest section will be fixed thereby, whereby an inexpensive one piece plastic construction is possible to form the tablet stand with efficiency and economy.

A Tablet computer holder and stand bearing US patent is issued to James W. Pollex. The patent discloses a handle assembly for a hand-held tablet computer or other handheld electronic device, the assembly including a tablet mounted assembly adhered to the back side of the tablet computer opposite the tablet's screen and a handle removably mounted to the tablet mounted assembly. The handle is rotatable permitting a user to hold the tablet computer within one hand and rotate the tablet computer to access the screen from any desired angle. The handle may include at least one tab and the tablet mounted portion includes at least one opening sized to receive the tab. The mounting plate may include a release tab to releasably engage a recess in the base plate of the handle to secure the tab of the handle within the opening of the mounting plate.

A Tablet computer holder and support bearing U.S. Pat. No. 8,235,334B1 is issued to Mark Kobal. The patent discloses a foldable support for a tablet computer or other object is an upright, self-standing or anchorable device. A base having foldout wings is adapted to be rotated in place and anchored under the legs of a person in a seated position, or under the person's torso for a reclining or supine person. The support includes a body with a recessed portion into which the base is attached about a horizontal axle to enable the rotation. Two arms are rotatably pinned together with the other ends attached to ball joints on the body and a receptacle. The receptacle holds the tablet computer or other object and includes a frame housing with rotatably attached rods that extend outwardly from side openings in the frame. A gripper is mounted to the far end of each rod to hold the corners or edges of the tablet computer or other object mounted between the grippers.

There are multiple inventions that have been proposed in prior art regarding tablet holder and mounting system. However, the utility of these systems has not been seen in advance form and for specialized needs. The other similar products in the market provides the hinges which aren't friction torque hinges. Moreover, the present assemblies require space for stand base or mounting clamps. The material and utility of movement of the holders is also restricted and doesn't allow a free 360 degree movement.

The current invention proposes a system which provides a friction torque hinges installed to give the freedom of worry-free manual angle tightening. The holder/stand height and angle can easily be adjusted 360 degree simply by moving arms around while at user's most comfortable posture. The assembly doesn't require manual tightening with a screw driver or screw knobs. The assembly has a magnet or holder clamp option to hold the tablet/smart phone device attached to the holder/stand. Once folded the assembly is hidden underneath of the tabletop thus space saving.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a device to hold a tablet computer or other object in close proximity to a seated person using the tablet computer, book or other object.

It is also the objective of the invention to provide a support which is self-standing and is preferably anchored in place close to the person so that it is remains closely aligned as per user's requirement.

It is further the objective of the invention to provide a system which is well-designed to be hidden and space saving when not in use and can be folded underneath the tabletop. When in use, the arms and the mounting clamp will not be in the way where user can still have your cup of coffee and mouse under tablet.

It is also the objective of the invention to provide a system which has provision of magnetic features to provide quick and easy mount and dismount of the tablet.

It is moreover the objective of the invention to provide a system which provides a hinge that allows freedom of not having to worry about falling down and manually tighten it with screws.

It is further the objective of the invention to provide a reliable system where the hinge provides complete 360 degree viewing positions and angles while at most comfortable sitting position.

It is moreover the objective of the invention to provide a system which is made of high-quality aluminum and aluminum die-cast materials to provide not only luxury look and feel, but very sturdy construction to last.

It is also the objective of the invention to provide a holder which can securely hold a plurality of electronic devices in any size and thickness, while providing complete protection and 360-degree view.

It is moreover the objective of the invention to provide a system where the tablet can be easily and quickly inserted into the apparatus and removed therefrom.

It is moreover the objective of the invention to provide a tablet holder which is of a durable and reliable construction

It is further the objective of the invention to provide a tablet holder which is easy to use, inexpensive and is easy to carry thus is highly portable and provides an advance methodology in similar domain.

It is also the objective of the invention to provide a tablet holder which is highly durable and useable for longer period of time.

An even further object of the present invention is to provide an advance tablet holder which is susceptible of a low cost of manufacture with regard to both materials and labor, and which accordingly is then susceptible of low prices of sale to the consuming public, thereby making such tablet holder are economically available to the buying public.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

Description of drawings as follows:

FIG. 1 is a complete perspective view of Task Clip Holder as per preferred embodiments of the invention.

FIG. 2 is an outline of multiple parts included in Task Mounting Base Clamp consisting of Task Base Clamp Handle (1), Task Mounting Clamp Screw Knob (2), Task Mounting Clamp Screw Plate (3), Task Mounting Clamp Protection Pad 1 (4), Task Mounting Clamp Protection Pad 2 (5), Task Base Clamp Deco 1 (6), Task Base Clamp Deco 2 (7), Task Base Clamp (8), Screw Washer (9) and Screw Nut (10) as per illustrative embodiments of the invention.

FIG. 3 is a complete view of extendable arm of assembly which can rotate 360 degree to allow maximum movement and convenience as per preferred embodiments of the invention.

FIG. 4 is a complete view of multiple parts included to form 360-degree moveable hand. The extendable arm includes Magnet Holder Cover Top (11), Task vertical Hinge 2 (12), Task Arm 2 (13), Task Arm 1 (14) and Task Mounting Base (15).

FIG. 5 is a perceptive view of magnet casing that will fit the magnet which in turn holds the tablet as per preferred embodiments of the invention.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses a hands-free tablet and smart phone devices holder/stand that can be affixed to any solid objects such as countertop, desk or other object.

The current invention as per its preferred embodiments provides a system which provides a high end multi arms system to hold and place the smart devices ranging from any thickness and size in secured and safe position. The assembly includes multiple arms which rotate with respect to one another. These arms are also, capable of rotating with respect to the other object to which it is affixed. It can be held at a height and angle that maximizes versatility adding convenience to the user.

The assembly is preferably made of high-quality aluminum which allows complete 360-degree movement of smart device as required by user without any feebleness. The assembly has joints made out of aluminum diecast or other similar rigid material allowing heavy torque force used on the hinges. The aluminum-built arms and diecasting joints and mounting clamps are made of sturdy structures to allow free and strong movement.

The assembly as per its further embodiment had few parts which are made with plastic materials. The customized special heavy-duty friction torque hinges in order to prolong hinge life and to produce higher torque force. The mounting clamp hinges must have snap-lock feature to hold 0- and 90-degree positions.

The assembly as per its further embodiment allows folded and dismounted for travel and storage purposes. The friction torque hinges installed give the freedom of manual angle tightening. The holder/stand height and angle can easily be adjusted 360 degree simply by moving arms around while at users' most comfortable posture. It comes with a magnet or holder clamp option to hold the tablet/smart phone device attached to the holder/stand. Once folded, it is hidden underneath of the tabletop thus space saving.

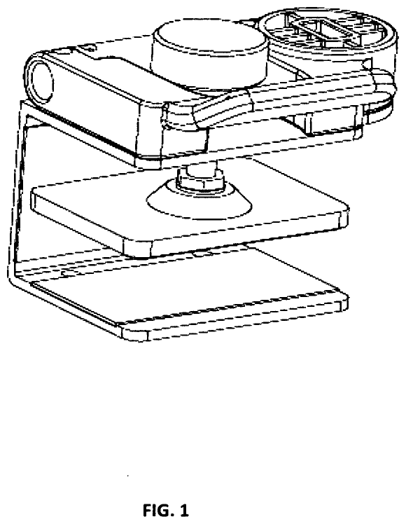

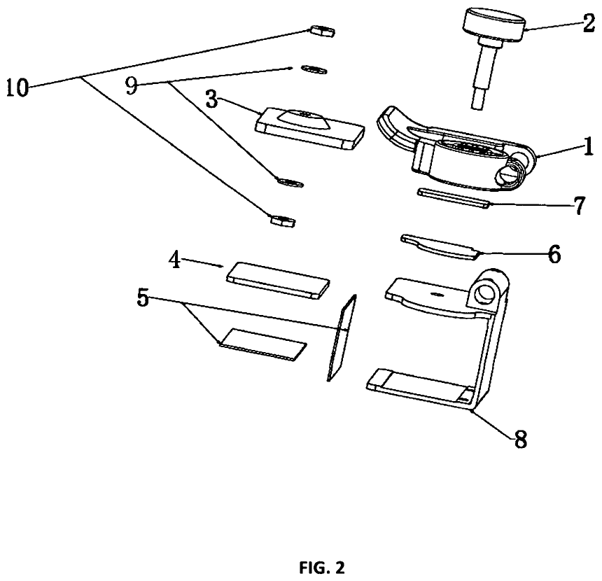

To explain the assembly further few drawings are added. FIG. 1 and FIG. 2 describe the Task Clip Holder where multiple parts included in Task Mounting Base Clamp consisting of Task Base Clamp Handle (1), Task Mounting Clamp Screw Knob (2), Task Mounting Clamp Screw Plate (3), Task Mounting Clamp Protection Pad 1 (4), Task Mounting Clamp Protection Pad 2 (5), Task Base Clamp Deco 1 (6), Task Base Clamp Deco 2 (7), Task Base Clamp (8), Screw Washer (9) and Screw Nut (10) as per illustrative embodiments of the invention.

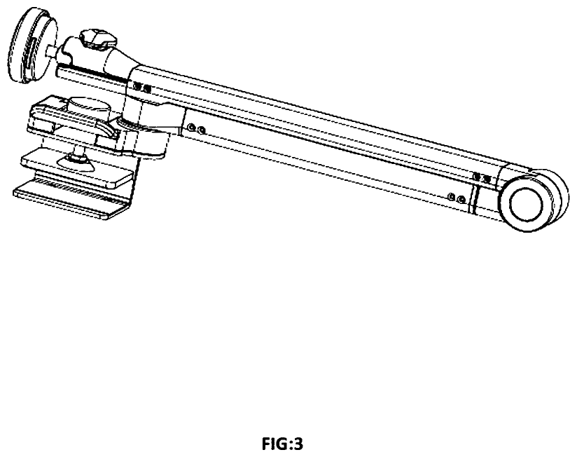

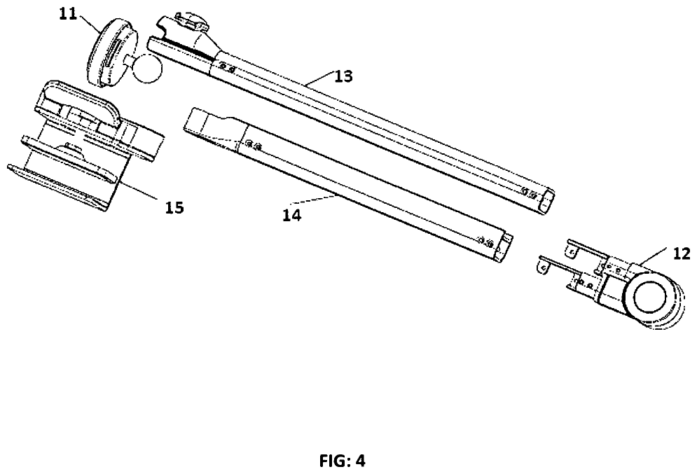

Furthermore, the FIG. 3 and FIG. 4, show other parts of extendable arm including Magnet Holder Cover Top (11), Task vertical Hinge 2 (12), Task Arm 2 (13), Task Arm 1 (14) and Task Mounting Base (15) where all parts are made of Aluminium and Aluminium die cast material to promote strength and long-term flexibility.

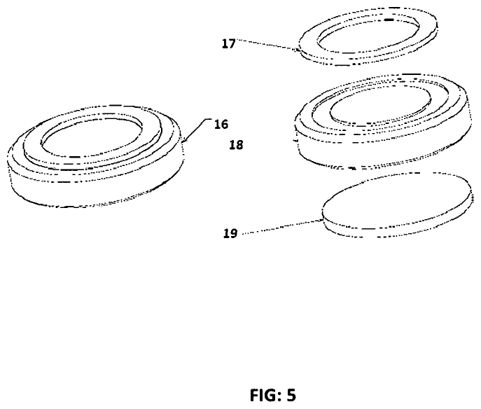

The FIG. 5 discloses casing which can be any size and it is made out of Aluminium die casting and/or any other types of material. It is also proposed to be filled with mylar or similar materials to block or reduce magnet force field damaging electronics. The labels (17), (18), (19) are showing multiple level of assembly joint together to form a finished form (16).

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. An apparatus for mounting the tablet comprising:
Aluminium built multiple arms;
multiple arms able rotate with respect to one another or to the object affixed;
diecasting joints;
mounting clamps and
magnet holder casing

2. The housing according to claim 1, wherein said housing provides:
a high quality and study materials including Aluminium and Aluminium diecast;
friction torque hinges installed to allow worry-free manual angle tightening;
the holder/stand height and angle which can easily be adjusted 360 degree by moving arms for desired angle;
completely hands-free to adjust positions and desired angles;
a magnet or holder clamp option to hold the tablet/smart phone device attached to the holder/stand and
multiple hands assembly able to be folded and dismounted for travel purpose.
